(19) United States
(12) Patent Application Publication
(10) Pub. No.: US 2024/0295028 A1
(43) Pub. Date: Sep. 5, 2024

(54) PRODUCTION METHOD FOR PLATED SUBSTRATE

(71) Applicant: National University Corporation, Iwate University, Iwate (JP)

(72) Inventors: Jing SANG, Iwate (JP); Hiroki MURAOKA, Iwate (JP); Hidetoshi HIRAHARA, Iwate (JP)

(21) Appl. No.: 18/572,323

(22) PCT Filed: Jun. 21, 2022
(86) PCT No.: PCT/JP2022/024721

§ 371 Date: Dec. 20, 2023

(30) Foreign Application Priority Data
Jun. 22, 2021 (JP) 2021-103360

(51) Int. Cl. C23C 18/18; C03C 17/10; C23C 18/16; C23C 18/32

(52) U.S. Cl. CPC C23C 18/1893; C03C 17/10; C23C 18/1639; C23C 18/1868; C23C 18/32; C03C 2217/261; C03C 2218/111; C03C 2218/31

(57) ABSTRACT

Provided is a production method for a plated substrate, comprising: providing a photoreactive bonding agent on a surface of a substrate made of glass or silicon; irradiating the surface of the substrate, on which the photoreactive bonding agent is provided, with light to allow the surface of the substrate and the photoreactive bonding agent to be bonded to each other; after the irradiation, removing by washing the photoreactive bonding agent that is not bonded to the surface of the substrate; after the first washing, providing a catalyst that binds to the photoreactive bonding agent; after the catalyst provision, removing by washing the catalyst that does not bind to the photoreactive bonding agent; and disposing a conductive substance on the photoreactive bonding agent by an electroless plating process after the second washing, the catalyst binding to the photoreactive bonding agent.

### TECHNICAL FIELD

The present invention relates to a production method for a plated substrate using a substrate made of glass or silicon.

### BACKGROUND ART

In recent years, substrates made of materials such as glass and silicon have been attracting attention in the field of electronics mounting, and a technique for forming plating on the substrates is also required. This is because substrates made of such materials have excellent characteristics such as high frequency characteristics, low transmission loss, low coefficient of thermal expansion, and dimensional stability.

Known methods for performing a plating process on the surface of a substrate made of a material such as glass or silicon include, for example, a method of vapor depositing metal in a vacuum, a method of sputtering metal, and a method of electroless plating. In a plated substrate subjected to the plating process for the surface of a substrate made of such a material, the interfacial adhesion between the substrate surface and the plating is an important characteristic, and modifications have been made to improve the interfacial adhesion.

For example, in a method of forming plating on the surface of a substrate by electroless plating, a known technique to improve the interfacial adhesion between the surface of a glass substrate and the plating includes performing an etching process on the substrate thereby to form fine irregularities on the substrate surface and then performing a silane coupling agent treatment and an electroless plating process (Patent Document 1).

### PRIOR ART DOCUMENTS

### Patent Documents

[Patent Document 1] JP2006-338837A

### SUMMARY OF THE INVENTION

### Problems to be Solved by the Invention

In the above method, however, the substrate surface has irregularities due to the etching process, so when the plated substrate is used for high frequency electronic components, this may not be preferred as it causes signal transmission loss and heat generation. Furthermore, when forming a fine pattern of conductor wiring on the substrate surface, there is also a problem in that the irregularities hinder the fine formation. There is therefore a need for a method of producing a plated substrate in which plating is formed with high interfacial adhesion and satisfactory peel strength on the smooth surface of a substrate made of a material such as glass or silicon.

The present invention has been made in view of such circumstances as above, and an object of the present invention is to provide a production method for a plated substrate in which the formed plating adheres tightly to the surface of the substrate of a material such as glass or silicon with sufficient peel strength even without forming irregularities on the substrate surface.

As a result of research to solve the above problems, the present inventors have accomplished the present invention after finding that it is possible to form plating with sufficient peel strength on the surface of a substrate made of glass or silicon even without forming irregularities on the substrate surface through a production method for a plated substrate, comprising: a bonding agent provision step for providing a photoreactive bonding agent on a surface of a substrate made of glass or silicon; an irradiation step for irradiating the surface of the substrate, on which the photoreactive bonding agent is provided, with light to allow the surface of the substrate and the photoreactive bonding agent to be bonded to each other; a first washing step for, after the irradiation step, removing by washing the photoreactive bonding agent that is not bonded to the surface of the substrate; a catalyst provision step for, after the first washing step, providing a catalyst that binds to the photoreactive bonding agent; a second washing step for, after the catalyst provision step, removing by washing the catalyst that does not bind to the photoreactive bonding agent; and a plating step for disposing a conductive substance on the photoreactive bonding agent by an electroless plating process after the second washing step, the catalyst binding to the photoreactive bonding agent.

Specifically, the present invention is as follows.

<1> A production method for a plated substrate, comprising:
a bonding agent provision step for providing a photoreactive bonding agent on a surface of a substrate made of glass or silicon;
an irradiation step for irradiating the surface of the substrate, on which the photoreactive bonding agent is provided, with light to allow the surface of the substrate and the photoreactive bonding agent to be bonded to each other;
a first washing step for, after the irradiation step, removing by washing the photoreactive bonding agent that is not bonded to the surface of the substrate;
a catalyst provision step for, after the first washing step, providing a catalyst that binds to the photoreactive bonding agent;
a second washing step for, after the catalyst provision step, removing by washing the catalyst that does not bind to the photoreactive bonding agent; and
a plating step for disposing a conductive substance on the photoreactive bonding agent by an electroless plating process after the second washing step, the catalyst binding to the photoreactive bonding agent.

<2> The production method for a plated substrate according to <1>, wherein irradiation in the irradiation step is performed by a method comprising: arranging a mask that masks a part of the surface of the substrate; and irradiating the mask with light thereby to selectively irradiating the surface of the substrate with light and/or by a method comprising selectively irradiating the surface of the substrate with convergent light.

<3> The production method for a plated substrate according to <1> or <2>, wherein
the photoreactive bonding agent is a compound that has a triazine ring and an alkoxysilyl group (including a case in which an alkoxy group in the alkoxysilyl group is OH) in one molecule and that further has a diazo group or an azide group.

<4> The production method for a plated substrate according to any one of <1> to <3>, wherein the photoreactive bonding agent is a compound represented by General Formula (1) or (2) below:

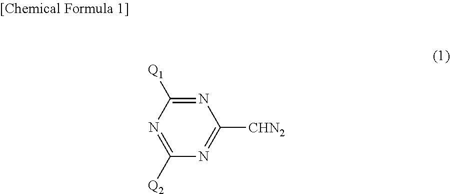

where at least one of -Q₁ or -Q₂ is —NR₁ (R₂) or —SR₁ (R₂), others are arbitrary groups, R₁ and R₂ are each H, a hydrocarbon group whose carbon number is 1 to 24, or —RSi(R′)ₙ(OA)₃₋ₙ(R is a chain hydrocarbon group whose carbon number is 1 to 12, R′ is a chain hydrocarbon group whose carbon number is 1 to 4, A is H or a chain hydrocarbon group whose carbon number is 1 to 4, and n is an integer of 0 to 2), and at least one of R₁ and R₂ is RSi(R′)ₙ(OA)₃₋ₙ,

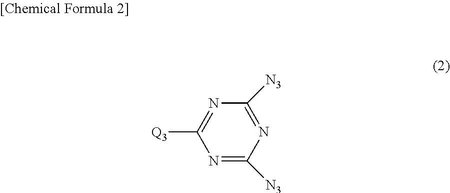

where -Q₃ is —NR₁ (R₂) or —SR₁ (R₂), R₁ and R₂ are each H, a hydrocarbon group whose carbon number is 1 to 24, or —RSi(R′)ₙ(OA)₃₋ₙ(R is a chain hydrocarbon group whose carbon number is 1 to 12, R′ is a chain hydrocarbon group whose carbon number is 1 to 4, A is H or a chain hydrocarbon group whose carbon number is 1 to 4, and n is an integer of 0 to 2), and at least one of R₁ and R₂ is RSi(R′)ₙ(OA)₃₋ₙ.

<5> The production method for a plated substrate according to any one of <1> to <4>, wherein the photoreactive bonding agent is a compound represented by General Formula (3) below:

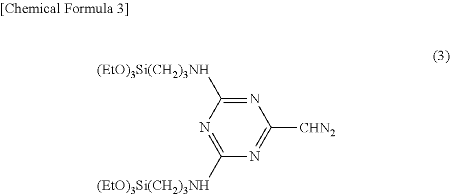

<6> The production method for a plated substrate according to any one of <1> to <4>, wherein the photoreactive bonding agent is a compound represented by General Formula (4) below:

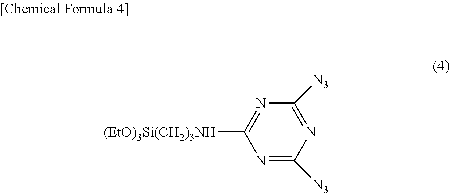

<7> The production method for a plated substrate according to any one of <1> to <6>, wherein light for irradiation in the irradiation step has a wavelength of 200 nm to 380 nm.

<8> The production method for a plated substrate according to any one of <1> to <7>, wherein the catalyst provided in the catalyst provision step is selected from the group consisting of Pd, Ag, and Cu.

### Advantageous Effect of the Invention

According to the production method for a plated substrate of the present inventions, it is possible to produce a plated substrate in which the formed plating adheres tightly to the surface of the substrate made of glass or silicon with sufficient peel strength even without forming irregularities on the substrate surface.

### BRIEF DESCRIPTION OF DRAWINGS

FIG. 1 is a set of schematic diagrams for describing the production method for a plated substrate according to an embodiment of the present invention.

FIG. 2 is a photograph of a stainless steel mask used in Examples.

FIG. 3 is a set of diagrams showing XPS spectra of the surfaces of pTES-treated substrates using silicon wafers.

FIG. 4 is a set of diagrams showing XPS spectra of the surfaces of pTES-treated substrates using glass.

FIG. 5 is a diagram listing the element ratios of the surfaces of pTES-treated substrates using silicon wafers with respect to the irradiation time.

FIG. 6 is a diagram listing the element ratios of the surfaces of pTES-treated substrates using glass with respect to the irradiation time.

FIG. 7 is a diagram illustrating the relationship between an N/Si value and an ultraviolet irradiation time in each pTES-treated substrate.

FIG. 8 is a set of diagrams each obtained by observing the surface shape of a pTES-treated substrate using an atomic force microscope.

FIG. 9 is a set of diagrams each showing the result of a tape peel test and the result of observing the surface with a laser microscope for a Ni-plated substrate (pTES-treated substrate) using a silicon wafer.

FIG. 10 is a set of diagrams each showing the result of a tape peel test and the result of observing the surface with a laser microscope for a Ni-plated substrate (pTES-treated substrate) using glass.

FIG. 11 shows a set of images of cross sections of Ni-plated substrates (pTES-treated substrates) observed with a transmission electron microscope.

FIG. 12 is a set of diagrams each showing the result of a tape peel test for a Ni-plated substrate (PC1-treated substrate).

FIG. 13 shows a set of images of cross sections of Ni-plated substrates (PCI-treated substrates) observed with a transmission electron microscope.

### EMBODIMENTS FOR CARRYING OUT THE INVENTION

Hereinafter, one or more embodiments of the present invention will be described. Note, however, that the present invention is not limited to the following embodiments.

The production method for a plated substrate according to the present embodiment includes: a bonding agent provision step for providing a photoreactive bonding agent on a surface of a substrate made of glass or silicon; an irradiation step for irradiating the surface of the substrate, on which the photoreactive bonding agent is provided, with light to allow the surface of the substrate and the photoreactive bonding agent to be bonded to each other; a first washing step for, after the irradiation step, removing by washing the photoreactive bonding agent that is not bonded to the surface of the substrate; a catalyst provision step for, after the first washing step, providing a catalyst that binds to the photoreactive bonding agent; a second washing step for, after the catalyst provision step, removing by washing the catalyst that does not bind to the photoreactive bonding agent; and a plating step for disposing a conductive substance on the photoreactive bonding agent by an electroless plating process after the second washing step, the catalyst binding to the photoreactive bonding agent.

### <Photoreactive Bonding Agent>

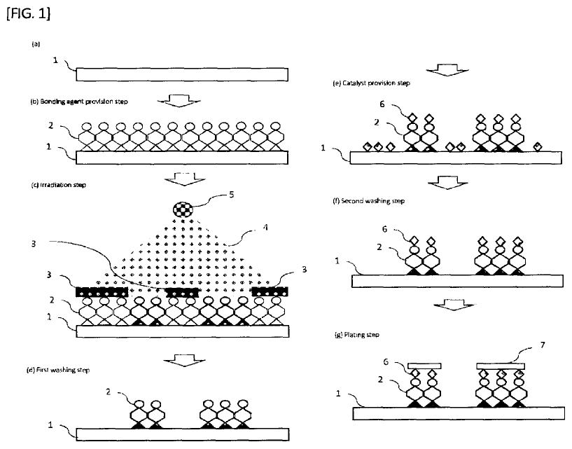

As illustrated in FIG. 1, a photoreactive bonding agent 2 used in the production method for a plated substrate according to the present embodiment is a substance that is bonded, after provided on the surface of the substrate 1, to a substrate 1 by light irradiation in the irradiation step, further binds to a catalyst 6 provided in the catalyst provision step, and serves as the basis of plating (conductive substance 7) formed in the plating step.

The photoreactive bonding agent used in the present embodiment has a photoreactive group and an interactive group within one molecule. The photoreactive group generates highly reactive chemical species upon irradiation with light and is bonded to the surface of a substrate made of glass or silicon. The interactive group interacts with a catalyst and binds to it. The interactive group may be a functional group that expresses interaction properties (bonding properties) with a catalyst through hydrolysis or the like.

The photoreactive bonding agent is preferably a compound that has a triazine ring and an alkoxysilyl group (including a case in which an alkoxy group in the alkoxysilyl group is OH) in one molecule and that further has a diazo group or an azide group. Here, the diazo group preferably binds to carbon and more preferably is a diazomethyl group.

Preferred usable examples of the triazine ring include 1,3,5-triazine. The alkoxysilyl group can be selected as a type of silanol-generating group. The silanol-generating group is a group that generates silanol by hydrolysis or the like. Any group having silicon and an alkoxy group can be selected as the alkoxysilyl group. Here, one or more other elements may be present between the silicon and the site at which the alkoxysilyl group binds to the triazine ring. For example, an amino group, a thio group, an oxy group, and/or a hydrocarbon group may be present between the silicon and the site at which the alkoxysilyl group binds to the triazine ring. The other elements present as above serve as a spacer when the substrate surface and the conductor wiring are bonded via the photoreactive bonding agent. When the photoreactive bonding agent of the present embodiment has two or more alkoxysilyl groups, the structures thereof may be the same or different.

In the above compound preferred as the photoreactive bonding agent, the diazo group or azide group is a photoreactive group, and the alkoxysilyl group can be an interactive group. The alkoxysilyl group produces a silanol group by hydrolysis, and the silanol group contributes to the interaction with the catalyst.

When the above compound has a diazo group, irradiation with light allows the carbon bonded to the diazo group to generate carbene (a two-coordinated carbon species having six valence electrons and two electrons that do not participate in bonding on carbon atoms), and such carbene sites cause a radical addition reaction to form chemical bonds with oxygen atoms (hydroxy groups (OH groups), silicon oxide film (SiO₂), etc.) present on the surface of the substrate. When the above compound has an azide group, irradiation with light allows the azide group to change to nitrene, and such nitrene sites cause a radical addition reaction to form chemical bonds with oxygen atoms (hydroxy groups (OH groups), silicon oxide film (SiO₂), etc.) present on the surface of the substrate. This allows the alkoxysilyl group of the above compound to be provided on the substrate surface.

The photoreactive bonding agent is more preferably a compound represented by General Formula (1) or General Formula (2) below.

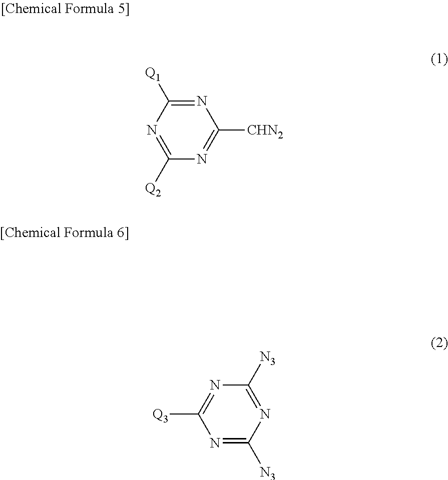

In General Formula (1), at least one of -Q₁ or -Q₂ is —NR₁(R₂) or —SR₁(R₂), and others are arbitrary groups. In General Formula (2), -Q₃ is —NR₁ (R₂) or —SR₁ (R₂).

R₁ and R₂ are each H, a hydrocarbon group whose carbon number is 1 to 24, or —RSi(R′)ₙ(OA)₃₋ₙ. The hydrocarbon group whose carbon number is 1 to 24 is a chain hydrocarbon group, a chain hydrocarbon group having a substituent (cyclic or chain), a cyclic group, or a cyclic group having a substituent (cyclic or chain). Examples thereof include —CₘH₂ₘ₊₁, —CₘH₂ₘ₋₁, —C₆H₅, —CH₂CH₂C₆H₅, —CH₂C₆H₅, and —C₁₀H₇. R in —RSi(R′)ₙ(OA)₃₋ₙ is a chain hydrocarbon group whose carbon number is 1 to 12 (e.g., —CₘH₂ₘ). R′ is a chain hydrocarbon group whose carbon number is 1 to 4 (e.g., —CₘH₂ₘ₊₁). A is H or a chain hydrocarbon group whose carbon number is 1 to 4 (e. g. , —CH₃, —C₂H₅, —CH (CH₃)₂, —CH₂CH (CH₃)₂, or —C(CH₃)₃). n is an integer of 0 to 2. At least one of R₁ and R₂ is —RSi(R′)ₙ(OA)₃₋ₙ. R₁ and R₂ may be the same or different. In the present specification, a group having a substituent (e.g., a hydrocarbon group) means, for example, one in which H of the group (e.g., a hydrocarbon group) is substituted with an appropriate substitutable functional group.

In General Formula (1), Q₁ and Q₂ may both be —HN—RSi(R′)ₙ(OA)₃₋ₙ or —S—RSi(R′)ₙ(OA)₃₋ₙ. That is, both -Q₁ and -Q₂ may be —NR₁, (R₂) or —SR₁, (R₂), or either R₁ or R₂ may be —RSi(R′)ₙ(OA)₃₋ₙ and the other may be H. Further, —HN—RSi(R′)ₙ(OA)₃₋ₙ or —S—RSi(R′)ₙ(OA)₃₋ₙ bonded to Q₁ and Q₂ may be the same or different. If they are the same, it can also be expressed that both Q₁ and Q₂ are —HN—R₃ and R₃ is RSi(R′)ₙ(OA)₃₋ₙ.

In General Formula (1), at least one of Q₁ and Q₂ may be —HN (CH₂)₃Si(EtO)₃ or —S(CH₂)₃Si(EtO)₃. Here, Et represents C₂H₅. Both Q₁ and Q₂ may be —HN(CH₂)₃Si(EtO)₃ or —S(CH₂)₃Si(EtO)₃. In this case, the photoreactive bonding agent is 2,4-bis[(3-triethoxysilylpropyl)amino]-6-diazomethyl-1,3,5-triazine (also referred to as PC1) represented by General Formula (3) below.

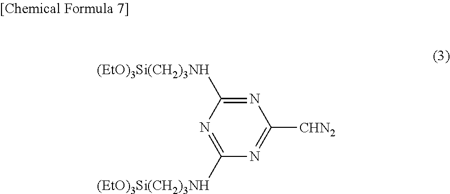

In General Formula (2), Q₃ may be —HN (CH₂)₃Si(EtO)₃ or —S(CH₂)₃Si (EtO)₃. Here, Et represents C₂H₅. In this case, the photoreactive bonding agent is 6-(3-triethoxysilylpropylamino)-1,3,5-triazine-2,4-diazide (also referred to as pTES) represented by General Formula (4) below.

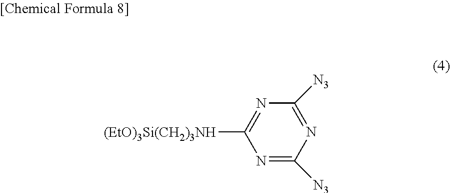

The production method for a plated substrate according to the present embodiment will now be described in more detail with reference to FIG. 1.

### <Substrate>

FIG. 1(a) illustrates the substrate 1 used in the production method for a plated substrate according to the present embodiment. The substrate used in the present embodiment is made of glass or silicon.

In the present specification, glass means a so-called amorphous inorganic substance that is obtained by rapidly cooling a molten liquid and solidifying it in a supercooled state without crystallizing it. Usable examples of the glass for a substrate include, but are not limited to, quartz glass, alkali-free glass, and borosilicate glass.

Silicon means a simple substance of silicon. Usable examples of the silicon for a substrate include, but are not limited to, silicon with a purity of “99.999999999%” (eleven nines).

In the production method for a plated substrate of the present invention, a plated substrate in which the substrate and the plating adhere sufficiently and tightly to each other can be obtained without preliminarily modifying the surface of the substrate. In the production method for a plated substrate of the present invention, the substrate may be cleaned by ultrasonic washing (e.g., washing for 5 minutes using acetone twice) before the bonding agent provision step. For a glass substrate, the substrate surface may be further washed using sodium hydroxide after ultrasonic cleaning and before the bonding agent provision step. Washing with sodium hydroxide increases the number of OH groups on the substrate surface that react with carbene and nitrene, and the bonding strength between the substrate surface and the photoreactive bonding agent can therefore be improved.

### «Bonding Agent Provision Step»

As illustrated in FIG. 1 (b), the bonding agent provision step according to the present embodiment is a step of providing the photoreactive bonding agent 2 on the surface of the substrate 1. Here, as the substrate 1 and the photoreactive bonding agent 2, those described above may be used.

The photoreactive bonding agent can be provided on the substrate, for example, as a photoreactive bonding agent solution (including a dispersion liquid) after being dissolved in a solvent. The provision method is not particularly limited and may be performed in various ways, such as immersing the substrate in the photoreactive bonding agent solution and spraying or roll-coating the photoreactive bonding agent solution onto the substrate. After this step, the photoreactive bonding agent provided is bonded to the substrate surface by the irradiation step, which will be described later.

The photoreactive bonding agent solution (including a dispersion liquid) is preferably provided on the substrate after dissolving the photoreactive bonding agent in a solvent within a range of 0.01 mass % to 0.5 mass %, but this range is further preferably 0.05 mass % to 0.3 mass % and particularly preferably 0.075% to 0.2 mass %. Being within the above range allows the substrate surface to be sufficiently coated, and the substrate surface can be coated with a single-molecule layer; therefore, the coated surface does not become rough or irregular, and sufficient adhesive strength can be obtained.

When the substrate is immersed in the photoreactive bonding agent solution (including a dispersion liquid), the immersion time is preferably 1 second to 10 minutes and more preferably 5 seconds to 6 minutes. Additionally or alternatively, the temperature of the photoreactive bonding agent solution (including a dispersion liquid) during the immersion is preferably 10° C. to 40° C. and more preferably 15° C. to 30° C. from the viewpoint of activity in the bonding ability of the photoreactive bonding agent.

The solvent for dissolving or dispersing the photoreactive bonding agent is not particularly limited, provided that dissolution or dispersion is possible. Usable examples of the solvent include water, alcohols such as methanol, ethanol, isopropanol, ethylene glycol, and diethylene glycol, ketones such as acetone and methyl ethyl ketone, esters such as ethyl acetate, halides such as methylene chloride, olefins such as butane and hexane, ethers such as tetrahydrofuran and butyl ether, aromatics such as benzene and toluene, and amides such as dimethylformamide and methylpyrrolidone. A mixed solvent obtained by mixing these various solvents may also be used.

The photoreactive bonding agent solution may also contain various components such as a stabilizer, a polymerization inhibitor, and a photodegradation inhibitor in addition to the photoreactive bonding agent.

### «Irradiation Step»

As illustrated in FIG. 1(c), the irradiation step according to the present embodiment is a step of irradiating the surface of the substrate 1, on which the photoreactive bonding agent 2 is provided in the bonding agent provision step, with light 4 to allow the surface of the substrate 1 and the photoreactive bonding agent 2 to be bonded to each other.

Irradiation in the irradiation step can be performed so as to selectively irradiate the surface of the substrate with light by a method comprising: arranging a mask that masks a part of the surface of the substrate; and irradiating the surface of the substrate with light and/or by a method comprising selectively irradiating the surface of the substrate with convergent light. By using any of these methods, a portion that is irradiated with light (a portion on which the conductive substance will be disposed later) can be formed so as to be clearly separated from a portion that is not irradiated with light (a portion on which the conductive substance will not be disposed later).

FIG. 1(c) schematically illustrates, as an example of the irradiation step, a method comprising: arranging a mask 3 that masks a part of the surface of the substrate 1; and irradiating the surface of the substrate 1 with light. In this method, the mask 3 that masks a part of the surface of the substrate 1 is arranged on or above the surface of the substrate 1 on which the photoreactive bonding agent 2 is provided in the bonding agent provision step, and then the surface of the substrate 1 is irradiated with light 4 from a light source 5. After irradiation with the light 4, the mask 3 is removed from the surface of the substrate 1. The material of the mask 3 is not particularly limited.

When adopting a method comprising selectively irradiating the surface of the substrate with convergent light, the direction of irradiation with the convergent light is preferably approximately perpendicular to the substrate surface. By irradiating the substrate surface with light in an approximately perpendicular direction, a portion that is irradiated with light can be more clearly separated from a portion that is not irradiated with light.

In the irradiation step, visible light can be used as the light for irradiation, but it is preferred to use ultraviolet rays, which are effective in activating the bonding ability of the photoreactive bonding agent to the substrate. Here, ultraviolet rays mean light having a wavelength range of 100 nm to 400 nm, but the wavelength range is more preferably 200 nm to 380 nm and particularly preferably 220 nm to 380 nm. In the above ranges, when the photoreactive bonding agent is a compound having a diazo group, the wavelength of light used for irradiation is preferably 200 nm to 380 nm and more preferably 220 nm to 380 nm. When the photoreactive bonding agent is a compound having an azide group, the wavelength of light used for irradiation is preferably 200 nm to 380 nm. When the wavelength of light used for irradiation is within the above range, the bonding ability of the photoreactive bonding agent to the substrate can be more sufficiently exhibited.

The time for irradiation with light in the irradiation step is preferably 1 second to 70 minutes, more preferably 1 second to 30 minutes, and particularly preferably 5 seconds to 10 minutes. In the above ranges, when the photoreactive bonding agent is a compound having a diazo group, the time for irradiation with light is preferably 5 seconds to 20 minutes and further preferably 10 seconds to 10 minutes. When the photoreactive bonding agent is a compound having an azide group, the time for irradiation with light is preferably 1 second to 20 minutes and further preferably 10 seconds to 10 minutes. When the time for irradiation with light is within the above range, the bonding ability of the photoreactive bonding agent to the substrate can be more sufficiently exhibited, and furthermore, the deterioration of the substrate that may occur due to irradiation with light can be suppressed.

The accumulated light amount for irradiation in the irradiation step is preferably 1 mJ/cm² to 1000 mJ/cm², more preferably 10 mJ/cm² to 100 mJ/cm², further preferably 30 mJ/cm² to 75 mJ/cm², and particularly preferably 40 mJ/cm² to 60 mJ/cm². In the above ranges, when the photoreactive bonding agent is a compound having a diazo group, the accumulated light amount for irradiation is preferably 20 mJ/cm² to 70 mJ/cm², more preferably 30 mJ/cm² to 60 mJ/cm², and particularly preferably 40 mJ/cm² to 60 mJ/cm². When the photoreactive bonding agent is a compound having an azide group, the accumulated light amount for irradiation is preferably 30 mJ/cm² to 60 mJ/cm², more preferably 40 mJ/cm² to 60 mJ/cm², and particularly preferably 40 mJ/cm² to 50 mJ/cm². When the accumulated light amount for irradiation is within the above range, the bonding ability of the photoreactive bonding agent to the substrate can be more sufficiently exhibited, and furthermore, the deterioration of the substrate that may occur due to irradiation with ultraviolet rays can be suppressed.

Usable examples of the light source for the irradiation step include an ultraviolet LED, a low-pressure mercury lamp, a high-pressure mercury lamp, an excimer laser, a barrier discharge lamp, and a microwave electrodeless discharge lamp.

When adopting a method comprising selectively irradiating the surface of the substrate with convergent light, it is common to use a lens system to converge the light emitted from a light source and irradiate the target portion with the convergent light. A Fresnel lens, a lens array, etc. can be used as the lens system. The spot diameter of an area on the substrate to be irradiated with the convergent light is appropriately selected depending on the wiring width of a product.

When the light source is a laser source, a nonlinear optical crystal can be used as substitute for a lens or lens system. When using a nonlinear optical crystal in this way, it is possible to convert the wavelength of an incident wave and use it. For example, a YAG laser beam having a wavelength of 1064 nm can be converted to a laser beam having a wavelength of 532 nm by installing a nonlinear optical crystal. Furthermore, by installing two stages of nonlinear optical crystals, it is possible to obtain ultraviolet light of 355 nm as a third harmonic wave. This allows the laser beam to have a wavelength necessary for the reaction of the photoreactive bonding agent.

### «First Washing Step»

As illustrated in FIG. 1(d), the first washing step according to the present embodiment is a step for, after the irradiation step, removing by washing the photoreactive bonding agent 2 that is not bonded to the surface of the substrate 1. This allows the photoreactive bonding agent 2 to remain only on the portions of the surface of the substrate 1 that are selectively irradiated with the light 4 in the irradiation step.

Examples of the washing method include, but are not limited to, solvent immersion and solvent washing. As the solvent used in the first washing step, an optimal solvent is used as appropriate depending on the type of photoreactive bonding agent provided in the bonding agent provision step, etc. Examples of the solvent include water, alcohol (such as methanol or ethanol), ketones, aromatic hydrocarbons, esters or ethers, and alkaline water. When a solution is used, the solvent in the solution may be dried by natural drying, heating, or the like. During the washing, means such as ultrasonic waves may be used in combination.

In an embodiment of the present invention, the series of steps comprising the above-described bonding agent provision step, irradiation step, and first washing step may be repeated multiple times, but even when the series of steps is performed only once, the photoreactive bonding agent can be sufficiently bonded to the substrate.

The thickness of the layer formed of the photoreactive bonding agent obtained in the above steps is preferably 0.5 to 500 nm and particularly preferably 0.5 to 100 nm.

### «Catalyst Provision Step»

As illustrated in FIG. 1(e), the catalyst provision step according to the present embodiment is a step for, after the first washing step, providing and bonding a catalyst 6 for electroless plating to the photoreactive bonding agent 2. In the present specification, when a catalyst is simply referred to, it encompasses the precursor.

A method of bonding a catalyst for electroless plating (e.g., metal colloid) and/or a precursor for electroless plating (e.g., metal salt) to the photoreactive bonding agent may include preparing a catalyst dispersion liquid in which metal colloid is dispersed in a suitable dispersion medium or a catalyst solution that contains metal ions dissociated from metal salt dissolved in an appropriate solvent and applying the catalyst dispersion liquid or catalyst solution to the substrate surface to which the photoreactive bonding agent is bonded, or immersing in the catalyst dispersion liquid or catalyst solution the substrate to which the photoreactive bonding agent is bonded.

Through such a method, the catalyst can be adsorbed onto the interactive groups in the photoreactive bonding agent using ion-ion interactions or dipole-ion interactions, or the photoreactive bonding agent can be impregnated with the catalyst. From the viewpoint of sufficiently performing such adsorption or impregnation, it is preferred to select an appropriate amount so that one chemical equivalent of the catalyst is adsorbed to one molecule of the photoreactive bonding agent.

The catalyst for electroless plating used in the catalyst provision step is mainly a zero-valent metal, and examples thereof include Pd, Ag, Cu, Ni, Al, Fe, and Co. In particular, Pd, Ag, and Cu are preferred because of their good handling ability and high catalytic ability. Usable examples of schemes of bonding such catalyst to the photoreactive bonding agent include a scheme of providing the photoreactive bonding agent with a metal colloid whose charge is adjusted so that the metal colloid interacts with an interactive group (e.g., a hydrophilic group) of the photoreactive bonding agent.

The precursor for the electroless plating catalyst used in the catalyst provision step is not particularly limited, provided that it can be an electroless plating catalyst through a chemical reaction. Metal ions of the zero-valent metal used in the above-described electroless plating catalyst may be mainly used. Metal ions, which are electroless plating catalyst precursors, become zero-valent metals, which are electroless plating catalysts, through a reduction reaction. The metal ions, which are electroless plating catalyst precursors, may be converted into zero-valent metals by a separate reduction reaction to become electroless plating catalysts after being provided to the photoreactive bonding agent and before being immersed in the electroless plating bath. Alternatively, the electroless plating catalyst precursors may be immersed in an electroless plating bath without any modification and converted into metals (electroless plating catalysts) using a reductant in the electroless plating bath. In a scheme of bonding such catalysts to the photoreactive bonding agent, for example, metal ions that are electroless plating catalyst precursors are provided in the form of metal salts to the photoreactive bonding agent. The metal salts to be used are not particularly limited, provided that they can be dissolved in a suitable solvent and dissociated into metal ions and bases (anions), and examples thereof include M(NO₃)ₙMClₙ, M_{2/n}(SO₄), and M_{3/n}(PO₄) (M represents an n-valent metal atom).

### «Second Washing Step»

As illustrated in FIG. 1(f), the second washing step according to the present embodiment is a step for, after the catalyst provision step, removing by washing the catalyst 6 (including a precursor of the catalyst), which does not bind to the photoreactive bonding agent 2 bonded to the surface of the substrate 1, from the substrate surface. This allows the catalyst 6 to remain only on the portions of the surface of the substrate 1 to which the photoreactive bonding agent 2 is bonded (i.e., the portions irradiated with the light 4 in the above irradiation step).

Examples of the washing method include, but are not limited to, solvent immersion and solvent washing. As the solvent used in the second washing step, an optimal solvent is used as appropriate depending on the type of photoreactive bonding agent used, the types of the catalyst and its precursor, etc. Examples of the solvent include water, methanol, ethanol, and alkaline water. During the washing, means such as ultrasonic waves may be used in combination.

### «Plating Step»

As illustrated in FIG. 1(g), the plating step according to the present embodiment is a step for disposing a conductive substance 7 on the photoreactive bonding agent 2, which is bonded to the substrate 1 and to which the catalyst 6 for electroless plating binds, by an electroless plating process. The plating step is performed after the catalyst 6 (including a precursor of the catalyst), which does not bind to the photoreactive bonding agent 2, is removed from the substrate surface by washing in the aforementioned second washing step. By performing electroless plating in the plating step, a high-density conductive substance (metal) film is formed on the substrate to which the photoreactive bonding agent is bonded. The formed conductive substance (metal) film has excellent interfacial adhesion to the substrate surface.

The electroless plating process refers to an operation in which metal is deposited through a chemical reaction using a solution containing metal ions that are to be deposited as plating. The electroless plating process is performed, for example, by immersing the substrate, to which the photoreactive bonding agent bound to the catalyst for electroless plating is bonded, in an electroless plating bath. Also when immersing the substrate, to which the photoreactive bonding agent bonded to the precursor for electroless plating is bonded, in an electroless plating bath, the substrate is immersed in the electroless plating bath, but in this case, the precursor is reduced in the electroless plating bath, followed by the electroless plating. A typically known electroless plating bath can be used as the electroless plating bath.

The main components of a typical electroless plating bath are metal ions for plating, a reductant, and additives (stabilizers) that improve the stability of the metal ions. In addition to these, known additives such as stabilizers for electroless plating baths may be contained in the electroless plating bath.

Known types of metal ions contained in electroless plating baths include ions such as those of copper, tin, lead, nickel (Ni), gold, palladium, and rhodium, among which copper, silver, gold, and nickel ions are more preferred from the viewpoint of conductivity.

The reductant and additives can be selected as appropriate depending on the type of metal ions. For example, a bath for electroless plating of copper contains Cu(SO₄)₂ as a copper salt, HCOH as a reductant, and chelating agents such as EDTA and Rochelle salt, which are stabilizers for copper ions, as additives. The plating bath used for electroless plating of CoNiP contains cobalt sulfate and nickel sulfate as metal salts, sodium hypophosphite as a reductant, and sodium malonate, sodium malate, and sodium succinate as complexing agents. The electroless plating bath for palladium contains (Pd(NH₃)₄)Cl₂ as metal ions, NH₃ and H₂NNH₂ as reductants, and EDTA as a stabilizer. These plating baths may contain components other than the above components.

The surface roughness (arithmetic average roughness Ra) of the conductive substance film (metal film) formed in the plating step is preferably 0.3 μm or less and more preferably 0.2 μm or less. The surface roughness within the above range can prevent the signal transmission loss and heat generation when the plated substrate is used as a circuit component.

The film thickness of the conductive substance film (metal film) formed in the plating step can be selected as appropriate depending on the metal salt or metal ion concentration of the plating bath, the immersion time in the plating bath, the temperature of the plating bath, etc., but is preferably 10 nm to 1000 nm and more preferably 20 nm to 500 nm. The film thickness within the above range allows the film to maintain sufficient conductivity, and the plated substrate can be sufficiently compact when used as a circuit component.

The plated substrate obtained through the plating step (electroless plating process) may be further subjected to an annealing process. This can reduce the plating stress and improve the peel strength.

Such an annealing process can be performed, for example, at a temperature of 50° C. to 600° C. for 5 minutes to 10 hours. The temperature of the annealing process may be set in one stage (T1) or in two or more stages (T1, T2, . . . ). The temperature change in the annealing process (e.g., room temperature→T1, T1→T2, T1 or T2→room temperature) is preferably performed by continuously changing the temperature over a predetermined period of time. The time required for temperature change can be, for example, 15 minutes to 5 hours in an embodiment or 1 to 3 hours in another embodiment.

When thickening the conductive substance film, it is also possible to form a film of the conductive substance by an electroless plating process and then perform an electroplating process to grow the metal film in a short time. The thickness of the conductive substance film (metal film) after the electroplating process can be selected as appropriate, but is preferably 1 μm to 50 μm.

The aforementioned embodiments are described to facilitate understanding of the present embodiment and are not described to limit the present embodiment. It is therefore intended that the elements disclosed in the above embodiments include all design changes and equivalents to fall within the technical scope of the present embodiment.

### EXAMPLES

Hereinafter, the present embodiment will be described in more detail by illustrating a specific example of the production method for a plated substrate, but the present embodiment is not limited to the following content.

### Example 1: Preparation of Plated Substrates-1

### Example 1-1: Bonding Process for Photoreactive Bonding Agent to Substrates

Two types of substrates were used: those made of silicon wafers (SiS-02-P2956) and those made of glass (D263Teco, SCHOTT). The substrates were repeatedly subjected to ultrasonic washing for 5 minutes using acetone twice.

The glass substrates were washed with acetone, sufficiently dried, then subjected to ultrasonic washing at 50° C. for 5 minutes using an aqueous sodium hydroxide solution (2 mass %), followed by washing with water, and thereafter repeatedly subjected to ultrasonic washing for 5 minutes using distilled water twice.

After washed and sufficiently dried, the substrates were immersed in a pTES solution (0.1 mass %) for 10 seconds at room temperature. The pTES solution was prepared by dissolving 0.1 g of a photoreactive bonding agent (6-(3-triethoxysilylpropylamino)-1,3,5-triazine-2,4-diazide (referred to as pTES, hereinafter)) represented by General Formula (4) below in 100 g of ethanol solvent.

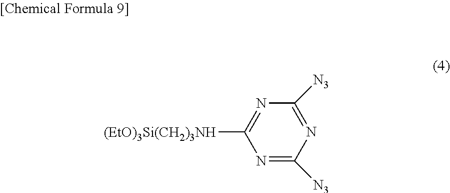

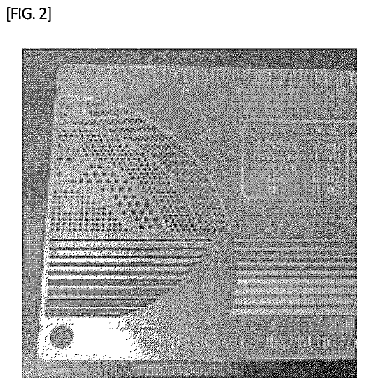

Then, the substrates were taken out from the pTES solution, and after they were sufficiently dried, stainless steel masks (see FIG. 2) were placed on the surfaces of the substrates. Subsequently, the surfaces of the substrates on which the masks were placed were irradiated with ultraviolet rays (main wavelength 365 nm, irradiation distance 10 cm) output from an ultraviolet irradiation device (SEN LIGHTS Corporation, HLR 100T-2). The irradiation time of ultraviolet rays was set to 0 seconds, 5 seconds, 30 seconds, 1 minute, 5 minutes, and 10 minutes (the accumulated light amount was 0 mJ/cm², 10 mJ/cm², 60 mJ/cm², 120 mJ/cm², 600 mJ/cm², and 1200 mJ/cm², respectively, each actually measured value). The accumulated light amount was obtained by measuring that of ultraviolet rays using an accumulated light amount meter (EYE GRAPHICS CO., LTD., accumulated UV illuminometer “UVPF-A1”) when irradiating each substrate with ultraviolet rays.

After the irradiation, each substrate was subjected to ultrasonic washing for 1 minute using ethanol in order to remove unreacted photoreactive bonding agent from the substrate surface, and was sufficiently dried to obtain a pTES-treated substrate.

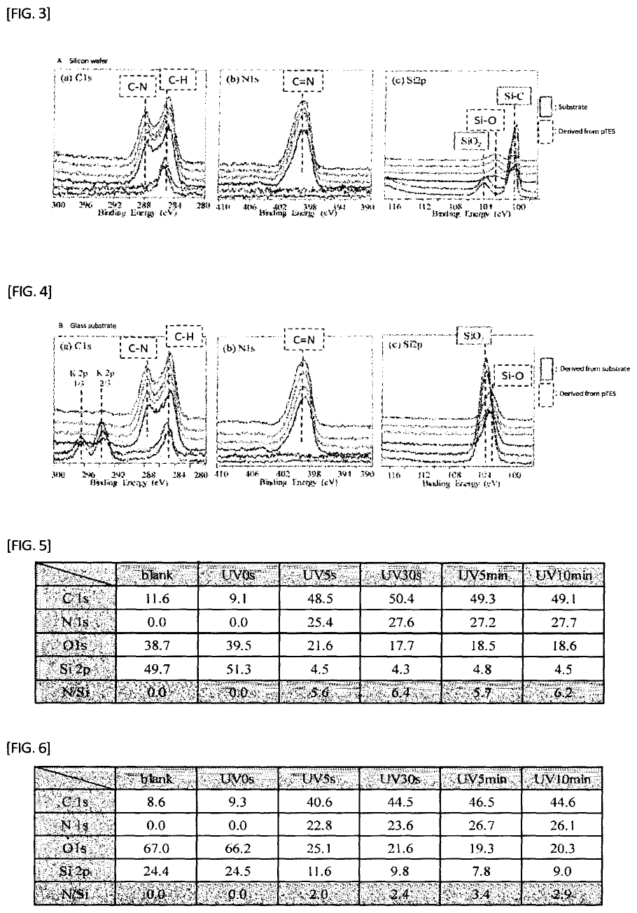

Here, to confirm the bonding between pTES and the substrate surface in each pTES-treated substrate, the chemical composition of the pTES-treated substrate surface was analyzed using an X-ray photoelectron analyzer (XPS, PHI Quantera II, ULVAC-PHI Inc.). The results of the analysis are shown or listed in FIGS. 3 to 7.

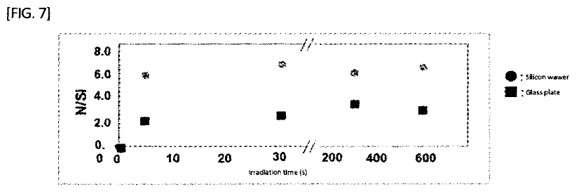

FIG. 3 shows the XPS spectra of silicon wafers, and FIG. 4 shows the XPS spectra of glass. The spectra in FIGS. 3(a) to (c) and FIGS. 4(a) to (c) are those obtained by analyzing the pTES-treated substrates with the ultraviolet irradiation times of 10 minutes, 5 minutes, 30 seconds, 5 seconds, and 0 seconds in order from the top, and the sixth spectra from the top are those obtained by analyzing the blank substrate surfaces. Here, the blank means a substrate to which pTES is not provided. FIG. 5 lists the analysis results of element ratios by XPS in pTES-treated substrates of silicon wafers, FIG. 6 lists the analysis results of element ratios by XPS in pTES-treated substrates of glass, and FIG. 7 illustrates the relationship between N/Si values calculated from these values and UV irradiation time. From these results, regardless of whether the substrates made of silicon wafers or the substrates made of glass were used, peaks derived from pTES were observed on the surface of each pTES-treated substrate subjected to ultraviolet irradiation, such as those of C—N, C═N, and Si—O, which were not observed on the blanks or the pTES-treated substrates with an ultraviolet irradiation time of 0 seconds. That is, it was confirmed that pTES was bonded to the substrate surface by ultraviolet irradiation.

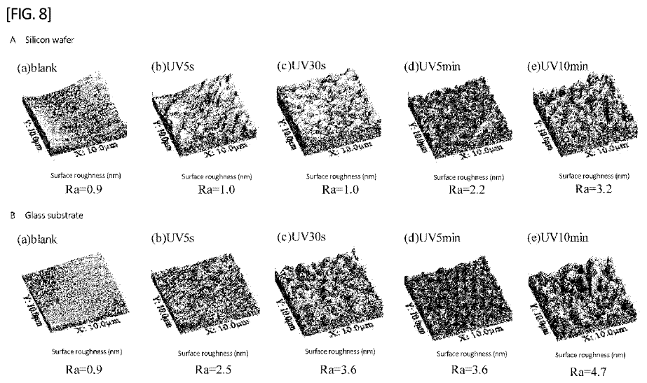

In addition, the shape of the surface of each pTES-treated substrate to which the pTES was bonded was observed using an atomic force microscope (AFM, Nanosurf Easyscan 2 AFM, Nanosurf AG). The results are shown in FIG. 8. The substrate surfaces were smooth on the blanks and the substrates with an ultraviolet irradiation time of 0 seconds, but on the surface of each pTES-treated substrate that was subjected to ultraviolet irradiation, fine irregularities formed due to bonding of pTES were confirmed.

### Example 1-2: Plating Process on Substrates

Subsequently, the pTES-treated substrates obtained in Example 1-1 were immersed in a catalyst treatment liquid for 1 minute thereby to allow the photoreactive bonding agent to support Pd as a catalyst. The catalyst treatment liquid was prepared by adding 0.023 g of PdCl₂ (Wako Pure Chemical Industries, Ltd.) to 200 mL of hydrochloric acid (35%, FUJIFILM Wako Pure Chemical Corporation) (10 ml/l) and dissolving it while stirring ultrasonically. Subsequently, the pTES-treated substrates were taken out from the catalyst treatment liquid and washed with pure water to remove from the substrate surfaces the catalyst that was not supported on the photoreactive bonding agent.

Then, the electroless plating process was performed by immersing the pTES-treated substrates supporting the catalyst in an electroless Ni plating liquid at 60° C. for 1 minute or 30 seconds. The electroless Ni plating liquid was prepared through adding 3 ml of KM, 3 ml of KA, 3 ml of KR, 1.5 ml of KE (C.Uyemura & Co., Ltd.) to 40.5 ml of distilled water, further adding 50.0 ml of distilled water, and performing ultrasonic stirring for 10 minutes.

After the electroless plating process, the substrates were washed with water and ethanol, sufficiently dried, and then annealed at 80° C. for 10 minutes to obtain Ni-plated substrates with Ni plating disposed on the substrate surfaces.

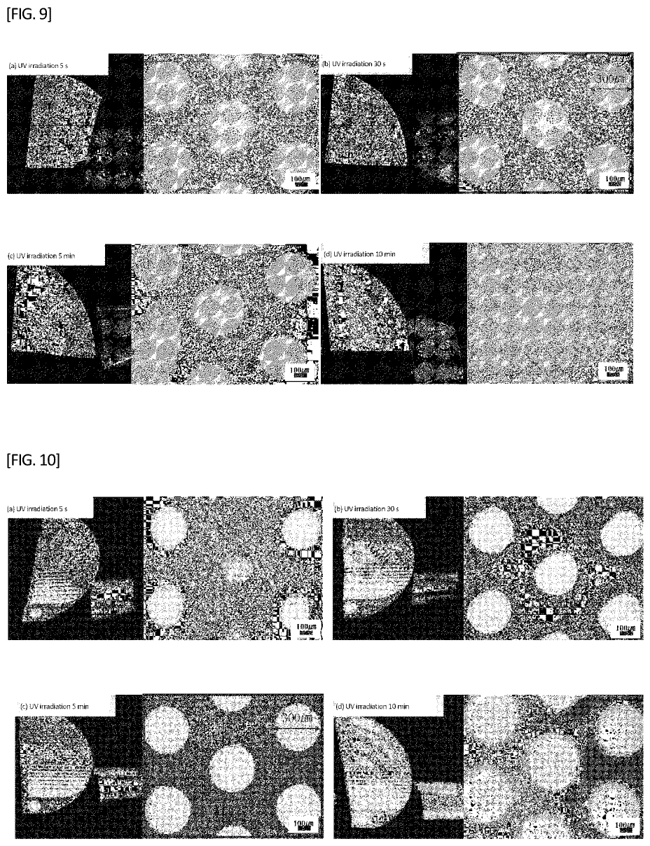

FIGS. 9 and 10 show the results of the tape peel test on the Ni-plated substrates obtained and the results of observing the surfaces of the Ni-plated substrates with a laser microscope (VK-9710, KEYENCE CORPORATION) according to the time of ultraviolet irradiation. In the tape peel test, whether or not the plating was peeled off from each Ni-plated substrate was verified through attaching a cellophane tape (NICHIBAN CO., LTD., product name: Cellotape (registered trademark) ) on the surface of the Ni-plated substrate on which the plating was disposed and then peeling off the cellophane tape. FIG. 9 shows the results of observing the Ni-plated substrates in which the substrates were silicon wafers and the electroless plating process was performed for 1 minute, and FIG. 10 shows the results of observing the Ni-plated substrates in which the substrates were glass and the electroless plating process was performed for 30 seconds. In both FIGS. 9(a) to (d) and FIGS. 10(a) to (d), the left images show the results of the tape peel test, and the right images show the results of observation with the laser microscope. From these results, it can be found that the Ni plating layers are formed on the substrate surfaces with sufficient interfacial adhesion.

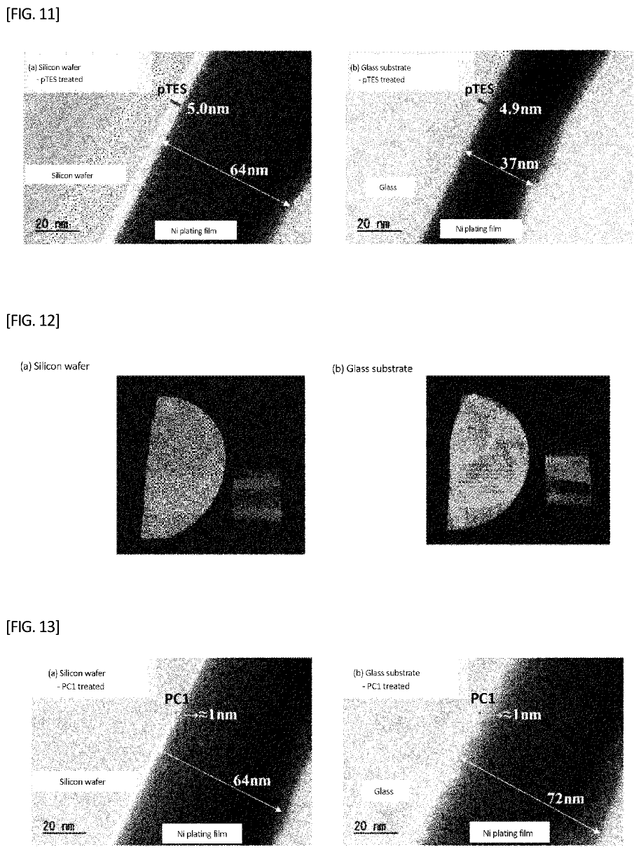

FIG. 11 shows images of the cross sections of the Ni-plated substrates observed with a transmission electron microscope (TEM, JEM-2100, JEOL Ltd., acceleration voltage: 200 kV). FIG. 11(a) shows the result of observing the cross section of a Ni-plated substrate using a silicon wafer as the substrate, irradiated with ultraviolet rays for 1 minute, and subjected to electroless plating for 1 minute. FIG. 11(b) shows the result of observing the cross section of a Ni-plated substrate using glass as the substrate, irradiated with ultraviolet rays for 1 minute, and subjected to electroless plating for 30 seconds. From each of FIGS. 11(a) and 11 (b), it can be found that a pTES layer and a Ni plating layer are laminated in order from the substrate surface.

### Example 2: Preparation of Plated Substrates-2

### Example 2-1: Bonding Process for Photoreactive Bonding Agent to Substrates

Two types of substrates were used: those made of silicon wafer (SiS-02-P2956) and those made of glass (D263Teco, SCHOTT). The substrates were repeatedly subjected to ultrasonic washing for 5 minutes using distilled water twice.

The glass substrates were washed with acetone, sufficiently dried, then subjected to ultrasonic washing at 50° C. for 5 minutes using an aqueous sodium hydroxide solution (2 mass %), followed by washing with water, and thereafter repeatedly subjected to ultrasonic washing for 5 minutes using acetone twice.

After washed and sufficiently dried, the substrates were immersed in a PC1 solution (0.1 mass %) for 10 seconds at room temperature. The PC1 solution was prepared by dissolving 0.1 g of a photoreactive bonding agent (2,4-bis[(3-triethoxysilylpropyl)amino]-6-diazomethyl-1,3,5-triazine (referred to as PC1, hereinafter) ) represented by General Formula (3) below in 100 g of ethanol solvent.

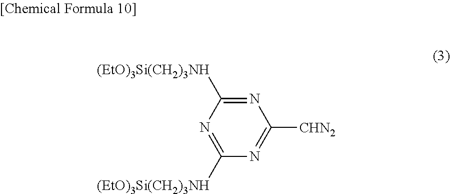

Then, the substrates were taken out from the PC1 solution, and after they were sufficiently dried, stainless steel masks (see FIG. 2) were placed on the surfaces of the substrates. Subsequently, the surfaces of the substrates on which the masks were placed were irradiated with ultraviolet rays (main wavelength 365 nm, irradiation distance 10 cm) output from an ultraviolet irradiation device (SEN LIGHTS Corporation, HLR 100T-2). The irradiation time of ultraviolet rays was set to 30 seconds (the accumulated light amount: 60 mJ/cm², actually measured value). After the irradiation, each substrate was subjected to ultrasonic washing for 1 minute using ethanol in order to remove unreacted photoreactive bonding agent from the substrate surface, and was sufficiently dried to obtain a PC1-treated substrate.

### Example 2-2: Plating Process on Substrates

Subsequently, the PC1-treated substrates obtained in Example 2-1 were immersed in a catalyst treatment liquid for 1 minute thereby to allow the photoreactive bonding agent to support Pd as a catalyst. The catalyst treatment liquid was prepared in the same manner as in Example 1-2. Subsequently, the PC1-treated substrates were taken out from the catalyst treatment liquid and washed with pure water to remove from the substrate surfaces the catalyst that was not supported on the photoreactive bonding agent.

Then, the electroless plating process was performed by immersing the PC1-treated substrates supporting the catalyst in an electroless Ni plating liquid at 60° C. for 1 minute or 30 seconds. The electroless Ni plating liquid was prepared in the same manner as in Example 1-2.

After the electroless plating process, the substrates were washed with water and ethanol, sufficiently dried, and then annealed at 80° C. for 10 minutes to obtain Ni-plated substrates with Ni plating disposed on the substrate surfaces.

FIG. 12 shows the results of the tape peel test on the Ni-plated substrates obtained. In the tape peel test, whether or not the plating was peeled off from each Ni-plated substrate was verified through attaching a cellophane tape (NICHIBAN CO., LTD., product name: Cellotape (registered trademark)) on the surface of the Ni-plated substrate on which the plating was disposed and then peeling off the cellophane tape. FIG. 12(a) shows the result of observing a Ni-plated substrate in which the substrate was a silicon wafer and the electroless plating process was performed for 1 minute, and FIG. 12(b) shows the result of observing a Ni-plated substrate in which the substrate was glass and the electroless plating process was performed for 30 seconds. From these results, it can be found that the Ni plating layers are formed on the substrate surfaces with sufficient interfacial adhesion.

FIG. 13 shows images of the cross sections of the Ni-plated substrates observed with a transmission electron microscope (TEM, JEM-2100, JEOL Ltd., acceleration voltage: 200 kV). FIG. 13(a) shows the result of observing the cross section of a Ni-plated substrate using a silicon wafer as the substrate and subjected to electroless plating for 1 minute. FIG. 13(b) shows the result of observing the cross section of a Ni-plated substrate using glass as the substrate and subjected to electroless plating for 1 minute. From each of FIGS. 13(a) and 13(b), it can be found that a PC1 layer and a Ni plating layer are laminated in order from the substrate surface.

### Example 3: Peel Strength Measurement of Plating-1

In the same manner as in Example 2 except that stainless steel masks were not used, the surface of a substrate made of a silicon wafer or glass was subjected to the bonding process with a photoreactive bonding agent (PC1), catalyst treatment, plating process, and annealing. In the plating process, Ni plating was performed on the silicon wafer while two types of Ni plating and Cu plating were performed on glass, and the processing time was set to 1 minute (Ni plating) or 15 minutes (Cu plating). In addition, a substrate made of ABS resin was also subjected to the bonding process with the photoreactive bonding agent in the same manner and was further subjected to a plating process to form Cu plating. ATS Adcopper IW (OKUNO CHEMICAL INDUSTRIES CO.,LTD.) was used as the electroless Cu plating liquid.

The peel strengths of the plating films of the plating-processed substrates thus obtained were measured using a SAICAS (Surface And Interfacial Cutting Analysis System) method. In the SAICAS method, measurements were conducted under the following conditions using SAICAS NN-05, a device available from DAIPLA WINTES CO., LTD. The results are listed in Table 1. The substrate made of glass or silicon and subjected to the plating process exhibited better peel strength than the substrate made of ABS and subjected to the plating process.

### =SAICAS Conditions=

Diamond cutting blade (cutting blade width 0.3 mm, C.DIA 20 10) was used
Diamond blade rake angle=20°, relief angle=10°, blade width=0.3 mm
Vertical speed=20 nm/sec, horizontal speed=100 nm/sec
Shear angle=45°

TABLE 1

| Substrate | Silicon | Glass | Glass | ABS |
|---|---|---|---|---|
| Photoreactive | PC1 | PC1 | PC1 | PC1 |
| bonding agent | | | | |
| Plating process | Ni | Ni | Cu | Cu |
| Peel strength | 0.18 | 0.30 | 0.18 | 0.13 |
| (kN/m) | | | | |

### Example 4: Peel Strength Measurement of Plating-2

### Example 4-1: Measurement of Peel Strength of Electroless Plating Film by SAICAS Method

In the same manner as in Example 1-1 except that stainless steel masks were not used, the surface of a substrate made of a silicon wafer or glass was subjected to the bonding process with a photoreactive bonding agent (pTES) The irradiation time of ultraviolet rays was set to 1 minute (the accumulated light amount was 120 mJ/cm², actually measured value). The obtained pTES-treated substrates were further subjected to the catalyst treatment and plating process. The catalyst treatment was performed in the same manner as in Example 1-2, and the processing time of the electroless plating process was set to 1 minute.

After the electroless plating process, the substrates were washed with water and ethanol, sufficiently dried, and then annealed to obtain Ni-plated substrates with Ni plating disposed on the substrate surfaces.

### =Annealing Conditions=

Room temperature−110° C.: 1 h
110° C.: 20 min
110° C.-250° C.: 1.5 h
250° C.: 30 min
250° C.-20° C.: 2.5 h

The peel strengths of the Ni-plating films of the Ni-plated substrates thus obtained were measured using the SAICAS method in the same manner as in Example 3. Also when pTES was used as the photoreactive bonding agent, satisfactory peel strength was exhibited.

TABLE 2

| Substrate | Silicon | Glass |
|---|---|---|
| Photoreactive | pTES | pTES |
| bonding agent | | |
| Plating process | Ni | Ni |
| Peel strength | 0.29 | 0.25 |
| (kN/m) | | |

### Example 4-2: Measurement of Peel Strength of Electroplating Film by Peel Test

The Ni-plated glass substrate obtained in Example 4-1 was further electroplated with Cu. A CuSO₄/H₂SO₄ aqueous solution (CuSO₄ concentration was 60 g/L) was used as the Cu electroplating liquid. Cu electroplating conditions were set with three stages of 0.004 A/cm²: 10 min→0.008 A/cm²: 10 min→0.016 A/cm²: 20 min.

After the Cu electroplating process, the substrate was washed with water and ethanol, sufficiently dried, and then annealed at 80° C. for 10 minutes to obtain a plating-processed substrate with Ni/Cu plating disposed on the substrate surface.

The peel strength of the plating film of the plating-processed substrate thus obtained was measured using a peel test. The peel test was conducted according to JIS K 6854-1 “Adhesives-Determination of peel strength of bonded assemblies Part 1: 90° peel.” The 90° peel strength of the obtained plating-processed substrate was 0.8 kN/m. Satisfactory peel strength was maintained even when thickened by Cu electroplating.

### DESCRIPTION OF REFERENCE NUMERALS

1 Substrate
2 Photoreactive bonding agent
3 Mask
4 Light
5 Light source
6 Catalyst
7 Conductive substance

1. A production method for a plated substrate, comprising:
a bonding agent provision step for providing a photoreactive bonding agent on a surface of a substrate made of glass or silicon;
an irradiation step for irradiating the surface of the substrate with light to allow the surface of the substrate and the photoreactive bonding agent to be bonded to each other, the photoreactive bonding agent being provided on the surface of the substrate;
a first washing step for, after the irradiation step, removing by washing the photoreactive bonding agent that is not bonded to the surface of the substrate;
a catalyst provision step for, after the first washing step, providing a catalyst that binds to the photoreactive bonding agent;
a second washing step for, after the catalyst provision step, removing by washing the catalyst that does not bind to the photoreactive bonding agent; and
a plating step for disposing a conductive substance on the photoreactive bonding agent by an electroless plating process after the second washing step, the catalyst binding to the photoreactive bonding agent.

2. The production method for a plated substrate according to claim 1, wherein irradiation in the irradiation step is performed by a method comprising: arranging a mask that masks a part of the surface of the substrate; and irradiating the mask with light thereby to selectively irradiating the surface of the substrate with light and/or by a method comprising selectively irradiating the surface of the substrate with convergent light.

3. The production method for a plated substrate according to claim 1, wherein
the photoreactive bonding agent is a compound that has a triazine ring and an alkoxysilyl group (including a case in which an alkoxy group in the alkoxysilyl group is OH) in one molecule and that further has a diazo group or an azide group.

4. The production method for a plated substrate according to claim 1, wherein the photoreactive bonding agent is a compound represented by General Formula (1) or (2) below: 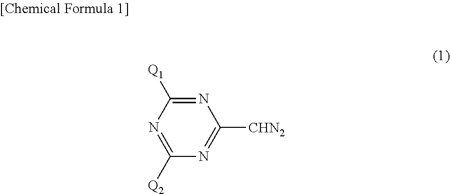
where at least one of -Q₁ or -Q₂ is —NR₁(R₂) or —SR₁(R₂), others are arbitrary groups, R₁ and R₂ are each H, a hydrocarbon group whose carbon number is 1 to 24, or —RSi(R′)ₙ(OA)₃₋ₙ (R is a chain hydrocarbon group whose carbon number is 1 to 12, R′ is a chain hydrocarbon group whose carbon number is 1 to 4, A is H or a chain hydrocarbon group whose carbon number is 1 to 4, and n is an integer of 0 to 2), and at least one of R₁ and R₂ is RSi(R′)ₙ(OA)₃₋ₙ, 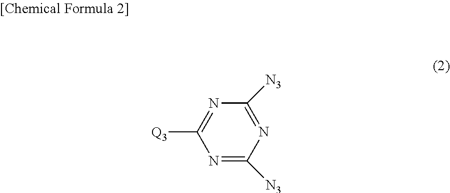
where -Q₃ is —NR₁(R₂) or —SR₁(R₂), R₁ and R₂ are each H, a hydrocarbon group whose carbon number is 1 to 24, or —RSi(R′)ₙ(OA)₃₋ₙ (R is a chain hydrocarbon group whose carbon number is 1 to 12, R′ is a chain hydrocarbon group whose carbon number is 1 to 4, A is H or a chain hydrocarbon group whose carbon number is 1 to 4, and n is an integer of 0 to 2), and at least one of R₁ and R₂ is RSi(R′)ₙ(OA)₃₋ₙ.

5. The production method for a plated substrate according to claim 1, wherein the photoreactive bonding agent is a compound represented by General Formula (3) below:

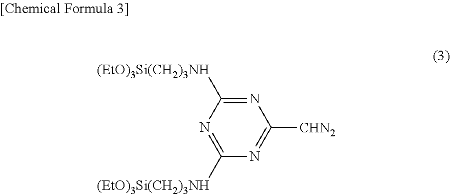

6. The production method for a plated substrate according to claim 1, wherein the photoreactive bonding agent is a compound represented by General Formula (4) below

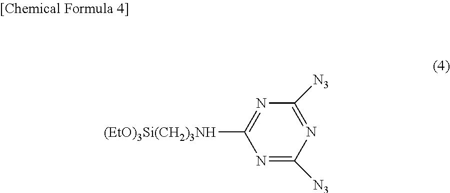

7. The production method for a plated substrate according to claim 1, wherein light for irradiation in the irradiation step has a wavelength of 200 nm to 380 nm.

8. The production method for a plated substrate according to claim 1, wherein the catalyst provided in the catalyst provision step is selected from the group consisting of Pd, Ag, and Cu.
